(19) United States
(12) Patent Application Publication
(10) Pub. No.: US 2009/0207847 A1
(43) Pub. Date: Aug. 20, 2009

(54) RELAY DEVICE AND RELAY METHOD

(75) Inventors: Kazuhiro TESHIMA, Fukuoka (JP); Masamichi Kasa, Fukuoka (JP)

Correspondence Address: Fujitsu Patent Center;C/O CPA Global, P.O. Box 52050, Minneapolis, MN, 55402, US

(73) Assignee: FUJITSU LIMITED, Kawasaki (JP)

(21) Appl. No.: 12/388,499

(22) Filed: Feb. 18, 2009

(30) Foreign Application Priority Data
Feb. 19, 2008 (JP) 2008-037872

(51) Int. Cl. H04L 12/56

(52) U.S. Cl. 370/395.31

(57) ABSTRACT

A relay device includes response frame transmitting technique for transmitting a response frame with the result of the inquiry to the effect that the source address coincident with the destination address to be inquired has been registered in the learning table to the relay device from which the inquiry frame was transmitted in the case that the registration judging technique has judged that the source address coincident with the destination address to be inquired has been registered in the learning table, and frame relaying technique for relaying the received frame whose relay has been temporarily postponed via the receiving port for the response frame in the case that the response frame was received.

### CROSS-REFERENCE TO RELATED APPLICATIONS

This application is based upon and claims the benefit of priority of the prior Japanese Application No. 2008-37872, filed on Feb. 19, 2008, the entire contents of which are incorporated herein by reference.

### FIELD

The embodiment relates to a relay device and a relay method.

### BACKGROUND

A conventional relay device is known which is equipped with a learning table for registering the source addresses of received frames so as to be associated with ports and in which each time a frame is received, the source address of the received frame is registered in the learning table so as to be associated with the port through which the received frame was received, and the received frame is relayed via the port corresponding to the source address coincident with the destination address of the received frame (refer to Japanese Laid-Open Patent Publication No. 2005-167881 or Japanese Laid-Open Patent Publication No. 2003-333061).

For example, in the relay device disclosed in Japanese Laid-Open Patent Publication No. 2005-167881 or Japanese Laid-Open Patent Publication No. 2003-333061, in the case that a frame has been received, the relay device extracts the frame's destination address from the received frame, retrieves the source address coincident with the destination address of the received frame from the learning table, and relays the received frame via a port (for example, port P1) corresponding to the retrieved source address (illustrated as FIG. 8A). In the case that the source address coincident with the destination address of the received frame has not been registered in the learning table, the relay device duplicates the received frame and relays the received frame via all the ports (for example, ports P1, P2, and P3) other than the port through which the received frame was received (illustrated as FIG. 8B). FIGS. 8A and 8B are views illustrating the outline of the conventional relay device.

However, in the above-mentioned technology, in the case that the source address coincident with the destination address of the received frame has not been registered in the learning table, there is a problem that excess traffic increases. In other words, in the conventional technology, even when multiple received frames with the same destination address are relayed, all the received frames are duplicated, and the received frames are relayed via all the ports other than the ports through which the received frames were received, whereby there is a problem that excess traffic increases.

### SUMMARY

According to an aspect of the embodiment, a relay device is equipped with a learning table for registering the source addresses of received frames so as to be associated with ports and in which each time a frame is received. The source address of the received frame is registered in the learning table so as to be associated with the port through which the received frame was received, and the received frame is relayed via the port corresponding to the source address coincident with the destination address of the received frame. The relay device includes an inquiry frame transmitting technique for temporarily postponing the relay of the received frame in the case that the source address coincident with the destination address of the received frame has not been registered in the learning table and for transmitting an inquiry frame inquiring whether the source address coincident with the destination address of the received frame has been registered in the learning table to all the relay devices connected to the ports other than the port through which the received frame was received; a registration judging technique for judging whether the source address coincident with the destination address to be inquired has been registered in the learning table in the case that the inquiry frame was received; a response frame transmitting technique for transmitting a response frame with the result of the inquiry to the effect that the source address coincident with the destination address to be inquired has been registered in the learning table to the relay device from which the inquiry frame was transmitted in the case that the registration judging technique has judged that the source address coincident with the destination address to be inquired has been registered in the learning table; and a frame relaying technique for relaying the received frame whose relay has been temporarily postponed via the receiving port for the response frame in the case that the response frame was received.

According to an aspect of the embodiment provides a relay method using a relay device which is equipped with a learning table for registering the source addresses of received frames so as to be associated with ports and in which each time a frame is received, the source address of the received frame is registered in the learning table so as to be associated with the port through which the received frame was received, and the received frame is relayed via the port corresponding to the source address coincident with the destination address of the received frame. The relay method includes temporarily postponing the relay of the received frame in the case that the source address coincident with the destination address of the received frame has not been registered in the learning table and for transmitting an inquiry frame inquiring whether the source address coincident with the destination address of the received frame has been registered in the learning table to all the relay devices connected to the ports other than the port through which the received frame was received; judging whether the source address coincident with the destination address to be inquired has been registered in the learning table in the case that the inquiry frame was received; transmitting a response frame with the result of the inquiry to the effect that the source address coincident with the destination address to be inquired has been registered in the learning table to the relay device from which the inquiry frame was transmitted in the case that the registration judging step has judged that the source address coincident with the destination address to be inquired has been registered in the learning table; and relaying the received frame whose relay has been temporarily postponed via the receiving port for the response frame in the case that the response frame was received.

Additional objects and advantages of the embodiment will be set forth in part in the description which follows, and in part will be obvious from the description, or may be learned by practice of the embodiment.

The object and advantages of the embodiment will be realized and attained by means of the elements and combinations particularly pointed out in the appended claims.

It is to be understood that both the foregoing general description and the following detailed description are exemplary and explanatory only and are not restrictive of the embodiment, as claimed.

### BRIEF DESCRIPTION OF THE DRAWINGS

FIGS. 1A to 1D are views illustrating the outline and features of a relay device according to Embodiment 1;

FIG. 2 is a block diagram illustrating the configuration of the relay device;

FIG. 3 is a view illustrating an example of information stored in a learning table;

FIG. 4 is a flowchart illustrating the flow of processing carried out by the relay device;

FIG. 5 is a block diagram illustrating the configuration of a relay device according to Embodiment 2;

FIG. 6 is a view illustrating an example of information stored in a learning table and a time management table according to Embodiment 2;

FIG. 7 is a view illustrating a computer that executes relay programs; and

FIGS. 8A and 8B are views illustrating the outline of a conventional relay device.

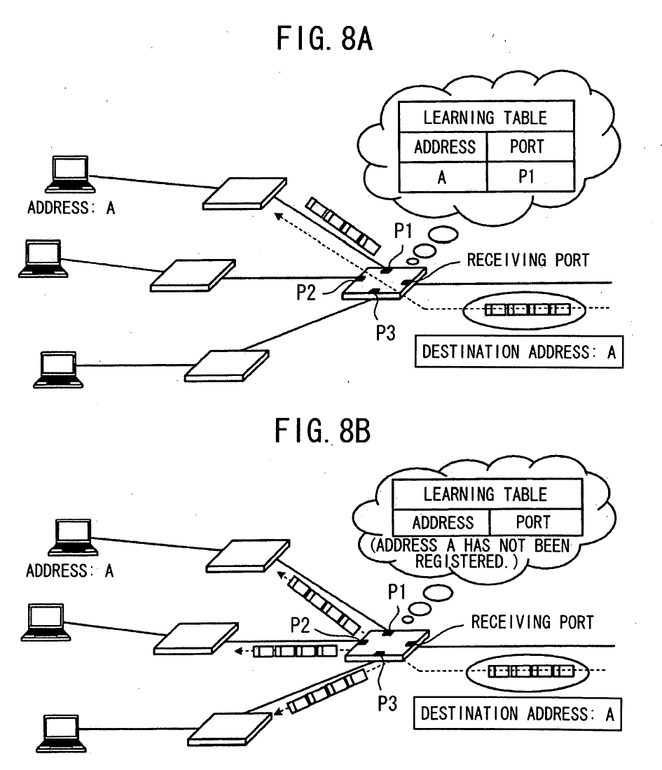

### DETAILED DESCRIPTION OF THE PREFERRED EMBODIMENTS

Embodiments of relay devices, relay methods, and relay programs according to the invention will be described below in detail referring to the accompanying drawings. Relay devices to which the invention is applied are described below as embodiments.

### Embodiment 1

In Embodiment 1 described below, the outline and features of a relay device according to Embodiment 1, the configuration of the relay device, and the processing flow of the relay device will be described in order, and the effects of Embodiment 1 will be described.

### Outline and Features of the Relay Device According to Embodiment 1

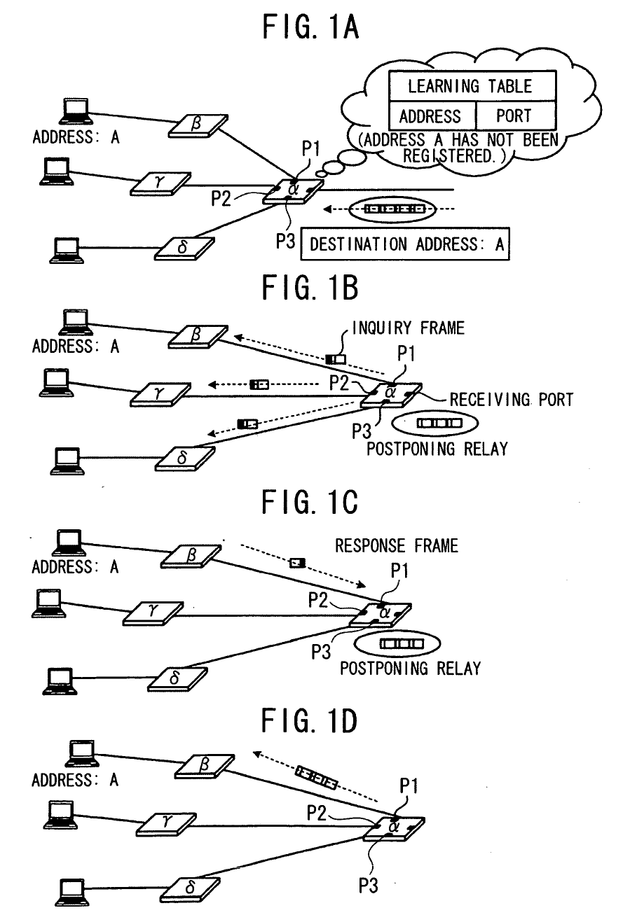

First, the outline and features of the relay device according to Embodiment 1 will be described referring to FIGS. 1A to 1D. FIGS. 1A to 1D are views illustrating the outline and features of the relay device according to Embodiment 1. As illustrated in FIGS. 1A to 1D, a relay device α is connected to a relay device β via a port designated by port number P1, to a relay device γ via a port designated by port number P2, and to a relay device δ via a port designated by port number P3.

The outline of the relay device according to Embodiment 1 is given as follows. In the above-mentioned network configuration, the relay device is equipped with a learning table for registering the source addresses of received frames so as to be associated with ports. Each time a frame is received, the source address of the received frame is registered in the learning table so as to be associated with the port through which the received frame was received, and the received frame is relayed via the port corresponding to the source address coincident with the destination address of the received frame.

The relay device according to Embodiment 1 is mainly characterized in that the increase in excess traffic is suppressed in the case that the source address coincident with the destination address of the received frame has not been registered in the learning table.

In other words, in the case that the relay device α has received a frame with destination address “A” for example, the relay device α extracts the destination address “A” from the received frame and retrieves the source address coincident with the destination address “A” of the received frame from the learning table.

In the case that the source address coincident with the destination address “A” of the received frame has not been registered in the learning table at this time (see FIG. 1A), the relay device α temporarily postpones the relay of the received frame and transmits an inquiry frame inquiring whether the source address coincident with the destination address of the received frame has been registered to all the relay devices connected via the ports other than the port through which the received frame was received (for example, the relay device β, the relay device γ, and the relay device γ connected via ports P1, P2, and P3, respectively) (see FIG. 1B).

The relay device β, the relay device γ, and the relay device δhaving received the inquiry frame judge whether the source address coincident with the destination address “A” to be inquired has been registered in their learning tables.

For example, as illustrated in FIG. 1C, in the case that the relay device β has judged that the source address coincident with the destination address “A” to be inquired has been registered in the learning table, the relay device β transmits a response frame with the result of the inquiry to the effect that the source address coincident with the destination address “A” to be inquired has been registered in the learning table to the relay device α from which the inquiry frame was transmitted.

After receiving the response frame, the relay device α relays the received frame whose relay has been temporarily postponed to the relay device β via the receiving port (port P1) for the response frame, (see FIG. 1D).

Hence, the relay device according to Embodiment 1 can suppress the increase in excess traffic in the case that the source address coincident with the destination address of the received frame has not been registered in the learning table as described above in the main features thereof.

[Configuration of the Relay Device]

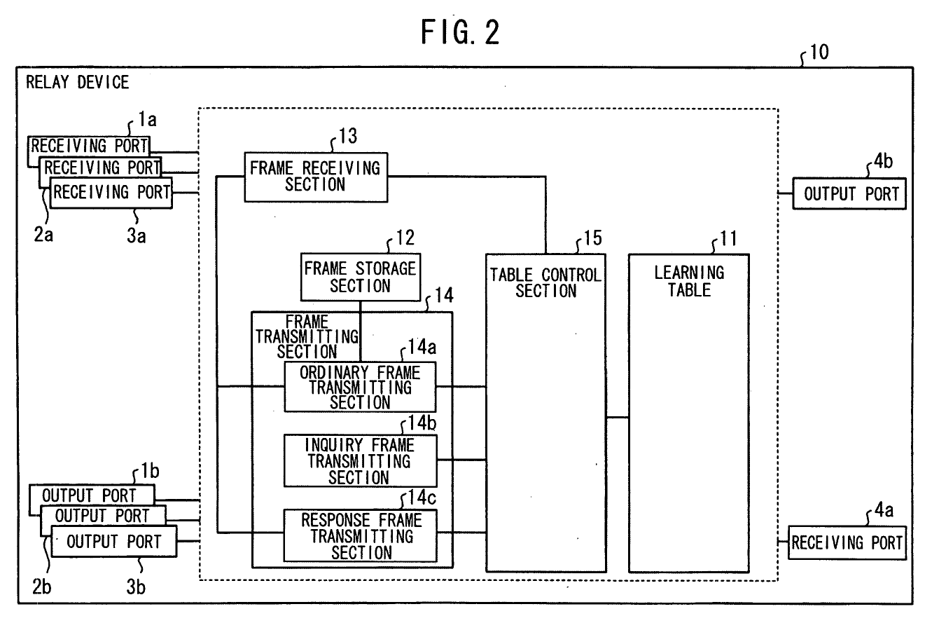

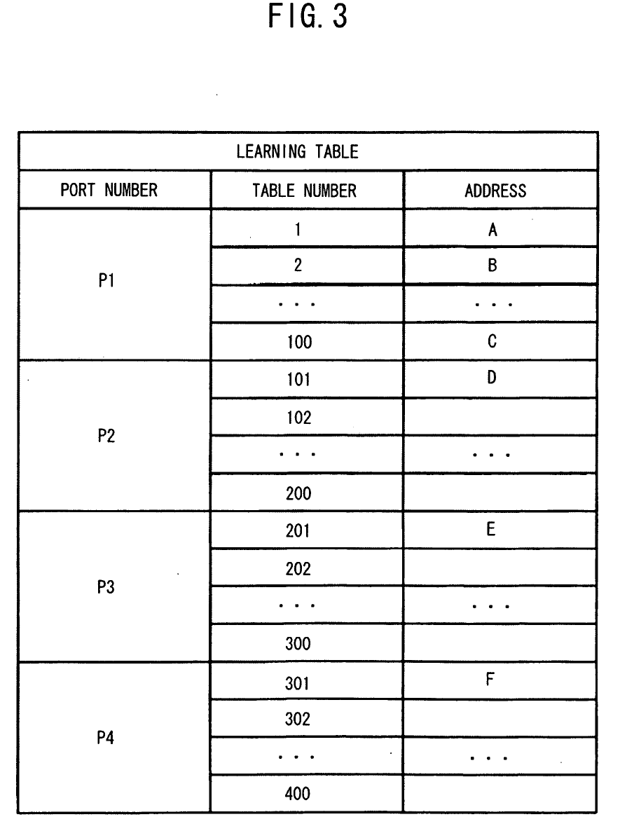

Next, the configuration of the relay device illustrated in FIGS. 1A to 1D will be described below referring to FIGS. 2 and 3. FIG. 2 is a block diagram illustrating the configuration of the relay device. FIG. 3 is a view illustrating an example of information stored in the learning table. As illustrated in FIG. 2, the relay device 10 comprises receiving port 1a to 4a, output port 1b to 4b, a learning table 11, a frame storage section 12, a frame receiving section 13, a frame transmitting section 14, and a table control section 15.

Among the components of the relay device, the receiving port 1a to 4a receive data from terminal devices connected via a network, and the output port 1b to 4b output data to the terminal devices connected via the network. In this configuration, the receiving port 1a and the output port 1b correspond to port number P1, the receiving port 2a and the output port 2b correspond to port number P2, the receiving port 3a and the output port 3b correspond to port number P3, and the receiving port 4a and the output port 4b correspond to port number P4.

The learning table 11 stores the source address of each received frame so as to be associated with a receiving port. More specifically, the learning table 11 stores table numbers (for example, 1 to 100) for each port number (for example, P1) through which frames are received and stores source addresses associated with the table numbers as illustrated in FIG. 3. A source address stored in the learning table 11 is hereafter simply referred to as “address.”

The frame storage section 12 stores a frame whose relay has been temporarily postponed. More specifically, the frame storage section 12 stores an ordinary frame whose address, being coincident with the destination address, has not been registered in the learning table 11.

Each time a frame is received, the frame receiving section 13 requests each component to carry out processing corresponding to the type of the received frame. More specifically, the frame receiving section 13 judges whether the received frame received via one of the receiving port 1a to 4a is an ordinary frame to be relayed.

In the case that the frame receiving section 13 has judged at this time that the received frame is an ordinary frame, the frame receiving section 13 transmits the source address extracted from the ordinary frame and the receiving port number of the port through which the ordinary frame was received to the table control section 15 and requests the table control section 15 to carry out learning processing. Then, the frame receiving section 13 transmits the destination address and the receiving port number of the ordinary frame extracted from the ordinary frame to the table control section 15 and requests the table control section 15 to carry out retrieving processing. Furthermore, the frame receiving section 13 transmits the ordinary frame to an ordinary frame transmitting section 14a, described later, and requests the ordinary frame transmitting section 14a to carry out frame relaying processing.

Furthermore, in the case that the frame receiving section 13 has judged that the received frame is not an ordinary frame, the frame receiving section 13 judges whether the received frame is an inquiry frame or a response frame.

In the case that the frame receiving section 13 has judged at this time that the received frame is an inquiry frame, the frame receiving section 13 extracts a source address to be inquired (hereafter referred to as an inquiry address) from the inquiry frame and transmits the inquiry address to the table control section 15 and then requests the table control section 15 to carry out inquiry address retrieving processing for judging whether the source address coincident with the inquiry address has been registered in the learning table 11. Then, the frame receiving section 13 transmits the port number of the port through which the inquiry frame was received to a response frame transmitting section 14c, described later, and requests the response frame transmitting section 14c to carry out response frame transmitting processing. Then, the frame receiving section 13 destroys the inquiry frame and completes the processing performed in the case that the frame receiving section 13 has judged that the received frame is an inquiry frame.

On the other hand, in the case that the frame receiving section 13 has judged that the received frame is a response frame, the frame receiving section 13 transmits the port number of the port through which the response frame was received to the ordinary frame transmitting section 14a, described later, and requests the ordinary frame transmitting section 14a to carry out frame relay restarting processing. Then, the frame receiving section 13 destroys the response frame and completes the processing performed in the case that the frame receiving section 13 has judged that the received frame is a response frame.

The frame transmitting section 14 includes the ordinary frame transmitting section 14a, an inquiry frame transmitting section 14b, and the response frame transmitting section 14c, and carries out frame transmitting processing.

In the case that the source address coincident with the destination address of the received frame has not been registered in the learning table 11, the ordinary frame transmitting section 14a temporarily postpones the relay of the received frame.

More specifically, in the case that the ordinary frame transmitting section 14a has received the request for frame relay processing together with an ordinary frame from the frame receiving section 13, the ordinary frame transmitting section 14a postpones the retrieval of the address coincident with the destination address of the ordinary frame, the retrieval being carried out by the table control section 15.

In the case that the ordinary frame transmitting section 14a has received at this time, from the table control section 15, the port number of the port through which the ordinary frame should be transmitted, the ordinary frame transmitting section 14a transmits the ordinary frame via the port having the port number.

On the other hand, in the case that the ordinary frame transmitting section 14a has received information from the table control section 15 to the effect that the address coincident with the destination address of the ordinary frame has not been registered in the learning table 11, the ordinary frame transmitting section 14a stores the ordinary frame in the frame storage section 12 and postpones the relay of the ordinary frame.

Furthermore, in the case that the ordinary frame transmitting section 14a has received, from the frame receiving section 13, the request for frame relay restarting processing together with the port number of the port through which the response frame was received, the ordinary frame transmitting section 14a transmits the ordinary frame stored in the frame storage section 12 via the port having that port number.

The inquiry frame transmitting section 14b transmits an inquiry frame inquiring whether the source address coincident with the destination address of the received frame has been registered in the learning table 11 to all the relay devices connected via the ports other than the port through which the received frame was received.

More specifically, in the case that the inquiry frame transmitting section 14b has received the destination address of the ordinary frame and the receiving port number for the ordinary frame from the table control section 15, the inquiry frame transmitting section 14b generates an inquiry frame in which the destination address of the ordinary frame is assigned as an inquiry address and transmits the inquiry frame to the relay devices 10 connected via the ports other than the port through which the ordinary frame was received.

In the case that it has been judged that the source address coincident with the inquiry address has been registered in the learning table 11, the response frame transmitting section 14c transmits a response frame with the result of the inquiry to the effect that the source address coincident with the inquiry address has been registered in the learning table to the relay device from which the inquiry frame was transmitted.

More specifically, in the case that the response frame transmitting section 14c has received, from the frame receiving section 13, the request for response frame transmitting processing together with the port number of the port through which the inquiry frame was received, the response frame transmitting section 14c postpones the retrieval of the address coincident with the inquiry address, the retrieval being carried out by the table control section 15.

In the case that the response frame transmitting section 14c has received information to the effect that the address coincident with the inquiry address has been registered in the learning table 11 from the table control section 15 at this time, the response frame transmitting section 14c generates a response frame with information to the effect that the address coincident with the inquiry address has been registered in the learning table 11 and transmits the response frame to the relay device 10 from which the inquiry frame was transmitted via the port through which the inquiry frame was received.

The table control section 15 registers the source address of the ordinary frame in the learning table 11 and retrieves the address coincident with the destination address of the ordinary frame (or the ordinary frame to be inquired) from the learning table 11.

More specifically, in the case that the table control section 15 has received the request for learning processing together with the source address of the ordinary frame and the receiving port number for the ordinary frame from the frame receiving section 13, the table control section 15 registers the source address of the ordinary frame in the learning table 11 so as to be associated with the receiving port number of the ordinary frame.

Furthermore, in the case that the table control section 15 has received the request for address retrieving processing together with the destination address of the ordinary frame and the receiving port number for the ordinary frame from the frame receiving section 13, the table control section 15 retrieves the address coincident with the destination address of the ordinary frame from the learning table 11.

In the case that the table control section 15 has retrieved the address coincident with the destination address of the ordinary frame at this time, the table control section 15 transmits, to the ordinary frame transmitting section 14a, the port number corresponding to this address as the port number of the port to which the ordinary frame should be transmitted.

On the other hand, in the case that the table control section 15 is unable to retrieve the address coincident with the destination address of the ordinary frame from the learning table 11, the table control section 15 transmits information to the effect that the address coincident with the destination address of the ordinary frame has not been registered in the learning table 11 to the ordinary frame transmitting section 14a and further transmits the destination address of the ordinary frame and the receiving port number for the ordinary frame to the inquiry frame transmitting section 14b.

Furthermore, in the case that the table control section 15 has received the inquiry address together with the request for inquiry address retrieving processing from the frame receiving section 13, the table control section 15 retrieves the address coincident with the inquiry address from the learning table 11.

In the case that the table control section 15 has retrieved the address coincident with the inquiry address from the learning table 11 at this time, the table control section 15 transmits information to the effect that the address coincident with the inquiry address has been registered in the learning table 11 to the response frame transmitting section 14c.

On the other hand, in the case that the table control section 15 was unable to retrieve the address coincident with the inquiry address from the learning table 11, the table control section 15 completes the inquiry address retrieving processing.

[Processing by the Relay Device]

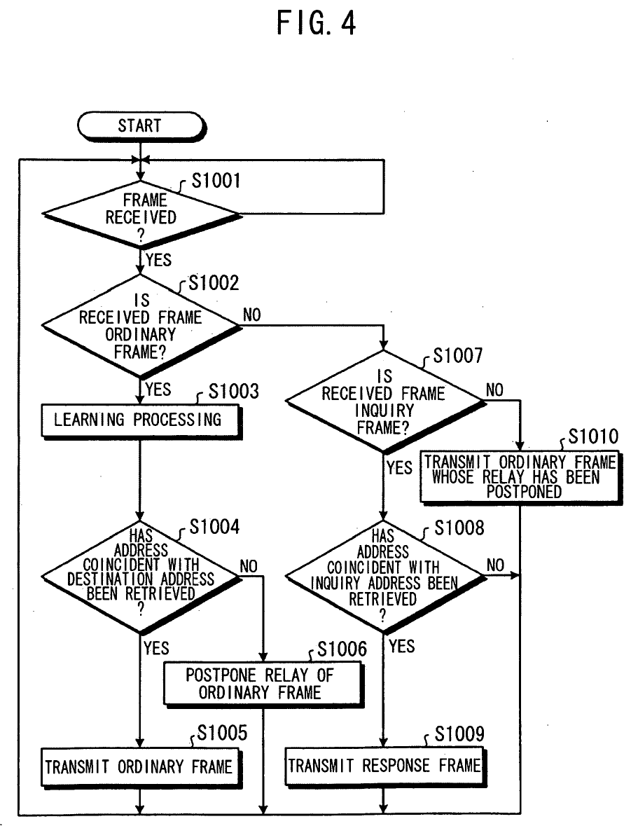

Next, the processing carried out by the relay device 10 will be described below. FIG. 4 is a flowchart illustrating the flow of the processing carried out by the relay device 10.

As illustrated in FIG. 4, when the relay device 10 has received a frame (YES at step S1001), the relay device 10 judges whether the received frame is an ordinary frame or not that should be relayed to a terminal device or relay device connected to the relay device (at step S1002).

In the case that the relay device 10 has judged at this time that the received frame is an ordinary frame (YES at step S1002), the relay device 10 carries out learning processing (at step S1003) and then carries out address retrieving processing (at step S1004).

In the case that the relay device 10 has retrieved the address coincident with the destination address of the ordinary frame from the learning table 11 at this time (YES at step S1004), the relay device 10 transmits the ordinary frame via the port having the port number corresponding to the retrieved address (at step S1005) and waits again for the reception of a frame (at step S1001).

On the other hand, in the case that the relay device 10 was unable to retrieve the address coincident with the destination address of the ordinary frame from the learning table 11 (NO at step S1004), the relay device 10 postpones the relay of the ordinary frame (at step S1006) and then waits again for the reception of a frame (at step S1001).

The processing at step S1002 is further described herein. In the case that the relay device 10 has judged that the received frame is not an ordinary frame (NO at step S1002), the relay device 10 further judges whether the received frame is an inquiry frame or a response frame (at step S1007).

In the case that the relay device 10 has judged at this time that the received frame is an inquiry frame (YES at step S1007), the relay device 10 carries out inquiry address retrieving processing (at step S1008).

In the case that the relay device 10 has retrieved the address coincident with the inquiry address from the learning table 11 at this time (YES at step S1008), the relay device 10 transmits a response frame with information to the effect that the address coincident with the inquiry address has been registered in the learning table 11 to the destination relay device 10 of the inquiry frame via the port through which the inquiry frame was received (at step S1009) and waits again for the reception of a frame (at step S1001).

On the other hand, in the case that the relay device 10 was unable to retrieve the address coincident with the inquiry address (NO at step S1008), the relay device 10 waits again for the reception of a frame (at step S1001).

The processing at step S1007 is further described herein. In the case that the relay device 10 has judged that the received frame is a response frame (NO at step S1007), the relay device 10 transmits the ordinary frame whose relay has been temporarily postponed via the port through which the response frame was received (at step S1010) and waits again for the reception of a frame (at step S1001).

### Effect of Embodiment 1

As described above, Embodiment 1 can suppress the increase in excess traffic in the case that the address coincident with the destination address of a received frame has not been registered in the learning table.

### Embodiment 2

In Embodiment 2, the relay device 10 described in Embodiment 1 will further be described by taking a more specific example. In Embodiment 2, the configuration of the relay device according to Embodiment 2 and the effect of Embodiment 2 will be described.

### Configuration of the Relay Device According to Embodiment 2

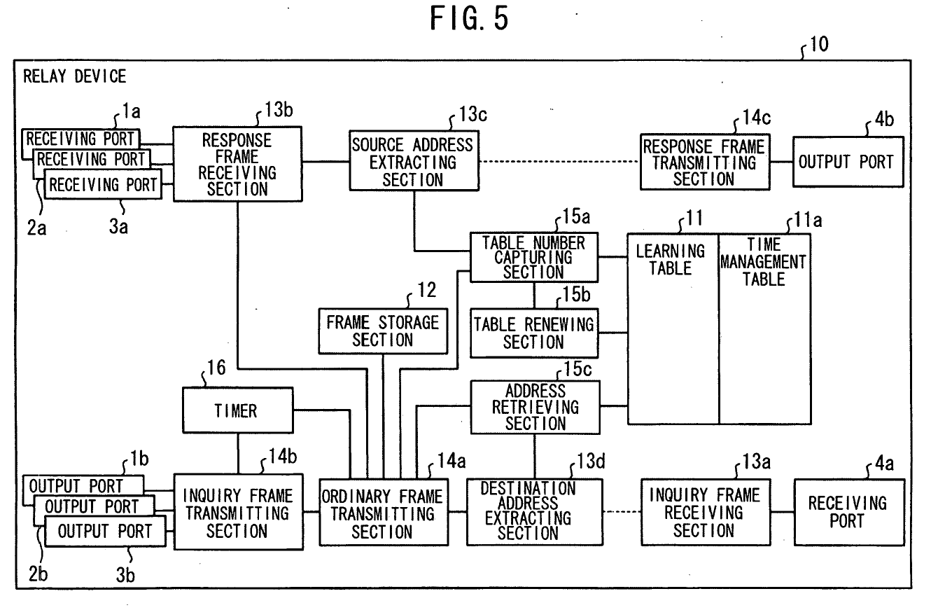

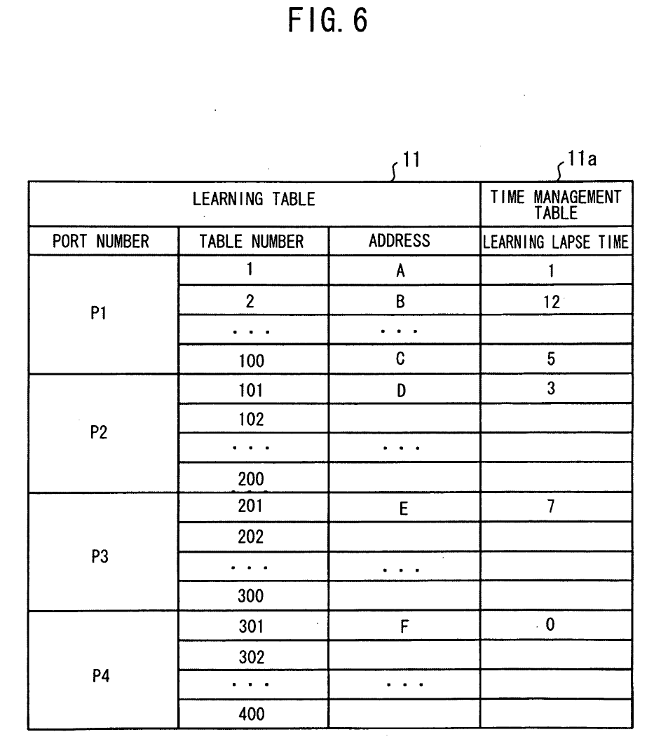

First, the configuration of the relay device 10 according to Embodiment 2 is described referring to FIGS. 5 and 6. The differences from Embodiment 1 are described in detail in the following. FIG. 5 is a block diagram illustrating the configuration of the relay device according to Embodiment 2. FIG. 6 is a view illustrating an example of information stored in a learning table 11 and a time management table according to Embodiment 2. The configuration of the relay device illustrated in FIG. 5 is described briefly for convenience of description. For example, it is assumed that a response frame receiving section 13b is also connected to the receiving port 4a. Furthermore, in Embodiment 2, differences from the relay device 10 according to Embodiment 1 are described in detail.

As illustrated in FIG. 5, the relay device 10 according to Embodiment 2 comprises receiving port 1a to 4a, output port 1b to 4b, a learning table 11, a time management table 11a, a frame storage section 12, an inquiry frame receiving section 13a, a response frame receiving section 13b, a source address extracting section 13c, a destination address extracting section 13d, an ordinary frame transmitting section 14a, an inquiry frame transmitting section 14b, a response frame transmitting section 14c, a table number capturing section 15a, a table renewing section 15b, an address retrieving section 15c, and a timer 16.

The inquiry frame receiving section 13a, the response frame receiving section 13b, the source address extracting section 13c, and the destination address extracting section 13d correspond to the frame receiving section 13 according to Embodiment 1, and the table number capturing section 15a, the table renewing section 15b, and the address retrieving section 15c correspond to the table control section 15 according to Embodiment 1.

The timer 16 serves as a clock or a self-timer for measuring time. More specifically, when an inquiry frame is transmitted from the inquiry frame transmitting section 14b, the timer 16 starts time measurements. When a preset lapse time has passed, the timer 16 transmits information to the effect that the preset lapse time has passed to the ordinary frame transmitting section 14a.

The time management table 11a stores learning lapse time, which is a time having passed after each address is registered, so as to be associated with each address registered in the learning table 11. The leaning lapse time is herein defined as the time for determining an address that is deleted from among the addresses registered in the learning table 11.

The inquiry frame receiving section 13a terminates the inquiry frame, transmits the inquiry address extracted from the inquiry frame to the destination address extracting section 13d, and destroys the inquiry frame.

The response frame receiving section 13b terminates the response frame, transmits the port number of the port through which the response frame was received to the ordinary frame transmitting section 14a, and destroys the response frame.

The source address extracting section 13c extracts a source address (for example, the source MAC address) from an ordinary frame (for example, a frame used for Ethernet (registered trademark)) input through the receiving ports 1a to 4a. Then, the source address extracting section 13c transmits the source address of the ordinary frame and the receiving port number for the ordinary frame to the table number capturing section 15a.

The destination address extracting section 13d extracts a source address (for example, the source MAC address) from an ordinary frame input through the receiving port 1a to 4a. Then, the destination address extracting section 13d transmits the destination address of the ordinary frame and the receiving port number for the ordinary frame to the address retrieving section 15c.

Furthermore, the destination address extracting section 13d transfers the inquiry address received from the inquiry frame receiving section 13a to the address retrieving section 15c.

In the case that the ordinary frame transmitting section 14a has received information from the table number capturing section 15a or the address retrieving section 15c to the effect that the ordinary frame should be destroyed, the ordinary frame transmitting section 14a destroys the ordinary frame. Furthermore, in the case that the ordinary frame transmitting section 14a has received information from the timer 16 to the effect that the preset lapse time has passed, the ordinary frame transmitting section 14a destroys the ordinary frame stored in the frame storage section 12.

After transmitting the inquiry frame, the inquiry frame transmitting section 14b starts time measurements using the timer 16.

The table number capturing section 15a refers to the learning table 11, captures a table number in which an address should be registered, and transmits the table number to the table renewing section 15b.

More specifically, the table number capturing section 15a refers to the learning table 11 and retrieves the address coincident with the source address of the ordinary frame received from the source address extracting section 13c.

In the case that the address coincident with the source address of the ordinary frame has been registered, the table number capturing section 15a refers to the port number corresponding to the address to the ordinary frame transmitting section 14a.

In the case that the port number corresponding to the address coincident with the source address of the ordinary frame is different from the receiving port number for the ordinary frame, the table number capturing section 15a transmits information to the effect that the ordinary frame should be destroyed to the ordinary frame transmitting section 14a.

On the other hand, in the case that the port number corresponding to the address coincident with the source address of the ordinary frame is the same as the receiving port number for the ordinary frame, the table number capturing section 15a captures the table number corresponding to the address and transmits the captured table number and the source address of the ordinary frame to the table renewing section 15b.

Furthermore, in the case that the address coincident with the source address of the ordinary frame has not been registered, when a table number is present in which no address is registered so as to be associated with the receiving port number for the ordinary frame, the table number capturing section 15a captures the table number and transmits the captured table number and the source address of the ordinary frame to the table renewing section 15b.

Moreover, in the case that the address coincident with the source address of the ordinary frame has not been registered, when addresses have already been registered in all the table numbers of the receiving port number for the ordinary frame, the table number capturing section 15a refers to the time management table 11a, captures the table number corresponding to the address that has the longest lapse time after the address was registered, and transmits the captured table number and the source address of the ordinary frame to the table renewing section 15b.

The table renewing section 15b registers the source address of the ordinary frame so as to be associated with the table number received from the table number capturing section 15a in the learning table 11. Then, the table renewing section 15b sets the learning lapse time stored in the time management table 11a to “0” so as to be associated with the table number received from the table number capturing section 15a. Furthermore, the table renewing section 15b carries out renewal by adding “1” to the leaning lapse time stored in the time management table 11a at preset fixed time intervals.

The address retrieving section 15c refers to the learning table 11 and retrieves the address coincident with the destination address of the ordinary frame received from the destination address extracting section 13d.

In the case that the address retrieving section 15c is unable to retrieve the address coincident with the source address of the ordinary frame from the learning table 11, the address retrieving section 15c transmits information to the effect that the address coincident with the source address of the ordinary frame has not been registered in the learning table 11 to the ordinary frame transmitting section 14a and transmits the destination address of the ordinary frame and the receiving port number for the ordinary frame to the inquiry frame transmitting section 14b.

On the other hand, in the case that the address retrieving section 15c has retrieved the address coincident with the destination address of the ordinary frame, the address retrieving section 15c judges whether the port number corresponding to this address is the same as the receiving port number for the ordinary frame.

In the case that the address retrieving section 15c has judged that the port number corresponding to the address coincident with the destination address of the ordinary frame is the same as the receiving port number for the ordinary frame, the address retrieving section 15c transmits information to the effect that the ordinary frame should be destroyed to the ordinary frame transmitting section 14a.

On the other hand, in the case that the address retrieving section 15c has judged that the port number corresponding to the address coincident with the destination address of the ordinary frame is not the same as the receiving port number for the ordinary frame, the address retrieving section 15c transmits the port number corresponding to this address as the port number of the port through which the ordinary frame should be transmitted to the ordinary frame transmitting section 14a.

Furthermore, the address retrieving section 15c refers to the learning table 11 and retrieves the address coincident with the inquiry address received from the destination address extracting section 13d. In the case that the address retrieving section 15c has retrieved the address coincident with the inquiry address from the learning table 11, the address retrieving section 15c transmits information to the effect that the address coincident with the inquiry address has been registered in the learning table 11 to the response frame transmitting section 14c.

### Effect of Embodiment 2

As described above, Embodiment 2 can suppress the increase in excess traffic in the case that the address coincident with the destination address of a received frame has not been registered in the learning table.

### Embodiment 3

In Embodiment 1 or Embodiment 2, in the case that multiple ordinary frames having the same destination address have been received, an inquiry frame may be generated by adding information inquiring whether the address coincident with the destination address of the ordinary frames has been registered to the ordinary frame first received.

Hence, in Embodiment 3, in the case that multiple ordinary frames having the same destination address have been received, the case in which an inquiry frame is generated by adding information inquiring whether the address coincident with the destination address of the ordinary frames has been registered to the ordinary frame first received will be described below. In Embodiment 3, the configuration of a relay device according to Embodiment 3 is described, and then the effect of Embodiment 3 is described.

### Configuration of the Relay Device According to Embodiment 3

First, the configuration of the relay device according to Embodiment 3 is described. The configuration of the relay device according to Embodiment 3 is different from the configuration of the relay device according to Embodiment 1 in the following respects.

In other words, in the case that the ordinary frame transmitting section 14a has received information to the effect that the address coincident with the destination address of ordinary frames has not been registered in the learning table 11 from the table control section 15, the ordinary frame transmitting section 14a checks if an inquiry inquiring to destination relay devices 10 whether the address coincident with the destination address of the ordinary frames has been registered is being carried out.

In the case that the ordinary frame transmitting section 14a has judged that the inquiry is being carried out, the ordinary frame transmitting section 14a stores the ordinary frames and postpones the relay of the ordinary frames.

On the other hand, in the case that the ordinary frame transmitting section 14a has judged that the inquiry is not being carried out, the ordinary frame transmitting section 14a transmits the ordinary frames to the inquiry frame transmitting section 14b and requests the inquiry frame transmitting section 14b to carry out inquiry frame transmitting processing.

The inquiry frame transmitting section 14b generates an inquiry frame by adding information inquiring whether the source address coincident with the destination address of the received frames has been registered to the received frame first received.

More specifically, in the case that the inquiry frame transmitting section 14b has received the request for inquiry frame transmitting processing together with the ordinary frames from the ordinary frame transmitting section 14a, the inquiry frame transmitting section 14b generates an inquiry frame by adding, to the ordinary frame first received, information (for example, a flag) specifying that the received ordinary frames are the ordinary frames to be inquired.

Then, the inquiry frame transmitting section 14b transmits the inquiry frame to the destination relay devices 10 via the ports other than the ports through which the ordinary frames were received.

### Effect of Embodiment 3

As described above, Embodiment 3 can reduce the delay due to temporarily postponing the relay of received frames. For example, in the case that one received frame whose source address coincident with the destination address has not been registered is received, the received frame is relayed without temporarily postponing the relay. Hence, it is possible to reduce the delay due to temporarily postponing the relay of the received frame.

### Embodiment 4

In Embodiments 1 to 3, in the case that a response frame has been received, the destination address of the received frame whose relay has been temporarily postponed may be registered so as to be associated with the port that has been registered in the learning table 11 and through which the response frame was received.

Hence, in Embodiment 4, in the case that the response frame was received, the case in which the destination address of the received frame whose relay has been temporarily postponed is registered so as to be associated with the port which has been registered in the learning table 11 and through which the response frame was received will be described below. In Embodiment 4, the configuration of a relay device according to Embodiment 4 is described, and then the effect of Embodiment 4 is described.

### Configuration of the Relay Device According to Embodiment 4

First, the configuration of the relay device according to Embodiment 4 is described. The configuration of the relay device according to Embodiment 4 is different from the configuration of the relay device according to Embodiment 1 in the following respects.

In other words, in the case that the frame receiving section 13 has judged that the received frame is a response frame, the frame receiving section 13 transmits the port number of the port through which the response frame was received to the table control section 15 and requests the table control section 15 to carry out learning processing.

In the case that the table control section 15 has received the port number of the port through which the response frame was received from the frame receiving section 13, the table control section 15 registers the destination address of the ordinary frame whose relay has been temporarily postponed so as to be associated with the receiving port number for the response frame in the learning table 11 as a destination address.

### Effect of Embodiment 4

As described above, Embodiment 4 can smoothly relay a received frame. For example, in the case that an ordinary frame having the same destination address as the address to be inquired has been received after a response frame was received, the ordinary frame can be relayed without temporarily postponing the relay. The received frame can thus be relayed smoothly.

### Embodiment 5

Although Embodiments 1 to 4 have been described above, the processing procedures, the control procedures, the specific names of the components, the information including various data and parameters (for example, the stored information illustrated in FIGS. 3 and 6) presented in the above-mentioned descriptions and figures may be modified as desired unless otherwise specified.

In addition, the components of the various devices illustrated in the figures are functionally conceptual and are not necessarily configured physically as illustrated in the figures. In other words, the actual separation or integration of the configurations of the devices are not limited to those illustrated in the figures, and part or whole of each device may be separated or integrated functionally or physically in arbitrary units depending on various kinds of loads and usages. For example, the ordinary frame transmitting section 14a and the inquiry frame transmitting section 14b illustrated in FIG. 2 may be integrated.

Furthermore, the various processing functions carried out by the various devices may be implemented using a CPU and programs that are analyzed and executed by the CPU or may be implemented as hardware comprising wired logic.

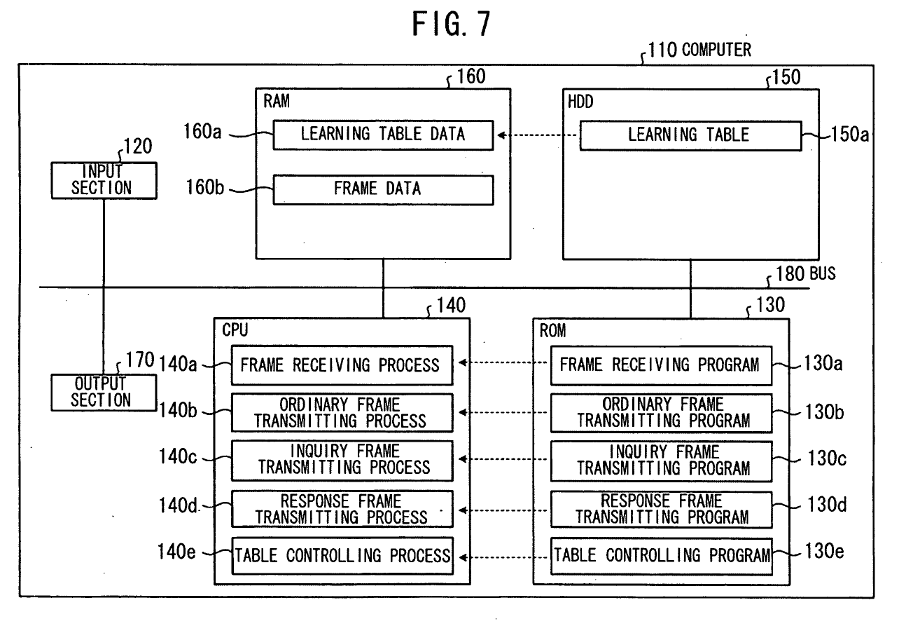

The invention may also be implemented by executing programs prepared in advance using a computer serving as the relay device 10. Hence, a computer that executes relay programs having functions similar to those of the relay device 10 described in the above-mentioned embodiments is taken as an example and described below referring to FIG. 7. FIG. 7 is a view illustrating a computer that executes relay programs.

As illustrated in FIG. 7, a computer 110 serving as the relay device 10 comprises an input section 120, a ROM 130, a CPU 140, an HDD 150, a RAM 160, and an output section 170, these being connected using a bus 180 and the like.

In the ROM 130, relay programs performing functions similar to those of the relay device 10 described in the above-mentioned Embodiment 1, such as a frame receiving program 130a, an ordinary frame transmitting program 130b, an inquiry frame transmitting program 130c, a response frame transmitting program 130d, and a table control program 130e, have been stored in advance as illustrated in FIG. 7. These programs 130a to 130e may be integrated or separated as necessary as in the case of the various components of the relay device 10 illustrated in FIG. 2.

The CPU 140 reads these programs 130a to 130e from the ROM 130 and executes them. As a result, the programs 130a to 130e may function as a frame receiving process 140a, an ordinary frame transmitting process 140b, an inquiry frame transmitting process 140c, a response frame transmitting process 140d, and a table controlling process 140e, respectively, as illustrated in FIG. 7. The processes 140a to 140e correspond to the frame receiving section 13, the ordinary frame transmitting section 14a, the inquiry frame transmitting section 14b, the response frame transmitting section 14c, and the table control section 15 illustrated in FIG. 2, respectively.

Furthermore, the HDD 150 is provided with a learning table 150a as illustrated in FIG. 7. The CPU 140 reads learning table data 160a from the learning table 150a and stores the learning table data 160a in the RAM 160. Processing is carried out on the basis of the learning table data 160a stored in the RAM 160 and frame data 160b stored in the RAM 160 by the ordinary frame transmitting process 140b. The learning table data 160a corresponds to the learning table 11 illustrated in FIG. 2, and the frame data 160b corresponds to the frame storage section 12 illustrated in FIG. 2.

The relay device, relay method, and relay programs disclosed in the invention can suppress the increase in excess traffic in the case that the source address coincident with the destination address of a received frame has not been registered in the learning table.

The above-mentioned programs 130a to 130e are not necessarily required to be stored in the ROM 130 in advance. The programs may be stored in, for example, portable physical media inserted into the computer 110, such as a flexible disk (FD), a CD-ROM disc, a DVD disc, a magnetic optical disc, and/or an IC card, fixed physical media provided inside or outside the computer 110, such as an HDD, or another computer (or a server) that is connected to the computer 110 via public lines, Internet, LAN, WAN, etc., and the programs may be read and executed using the computer 110.

Furthermore, the relay method described in the embodiments may be attained by executing programs prepared in advance using a computer, such as a personal computer or a workstation. These programs may be distributed via a network, such as the Internet. Moreover, the programs are stored in recording media that can be read using a computer, such as a hard disk, a flexible disk (FD), a CD-ROM disc, an MO disc, and/or a DVD disc, and read from the recording media, thereby being executable using a computer.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A relay device which is equipped with a learning table for registering the source addresses of received frames so as to be associated with ports and in which each time a frame is received, the source address of the received frame is registered in the learning table so as to be associated with the port through which the received frame was received, and the received frame is relayed via the port corresponding to the source address coincident with the destination address of the received frame, comprising:
inquiry frame transmitting technique for temporarily postponing the relay of the received frame in the case that the source address coincident with the destination address of the received frame has not been registered in the learning table, and for transmitting an inquiry frame inquiring whether the source address coincident with the destination address of the received frame has been registered in the learning table to all the relay devices connected to the ports other than the port through which the received frame was received;
registration judging technique for judging whether the source address coincident with the destination address to be inquired has been registered in the learning table in the case that the inquiry frame was received;
response frame transmitting technique for transmitting a response frame with the result of the inquiry to the effect that the source address coincident with the destination address to be inquired has been registered in the learning table to the relay device from which the inquiry frame was transmitted in the case that the registration judging technique has judged that the source address coincident with the destination address to be inquired has been registered in the learning table; and
frame relaying technique for relaying the received frame whose relay has been temporarily postponed via the receiving port for the response frame in the case that the response frame was received.

2. The relay device according to claim 1, further comprising destination address judging technique for judging whether the destination address of a received frame is coincident with the destination address being inquired in the case that the received frame was received, wherein
the inquiry frame transmitting technique temporarily postpones the relay of the received frame in the case that the destination address judging technique has judged that the destination address of the received frame is coincident with the destination address being inquired; and the inquiry frame transmitting technique transmits the inquiry frame generated by adding information inquiring whether the source address coincident with the destination address of the received frame has been registered in the learning table to the received frame in the case that the destination address judging technique has judged that the destination address of the received frame is different from the destination address being inquired.

3. The relay device according to claim 1 or 2, further comprising address registering technique for registering the destination address to be inquired in the learning table so as to be associated with the port through which the response frame was received in the case that the response frame was received.

4. A relay method, using a relay device which is equipped with a learning table for registering the source addresses of received frames so as to be associated with ports and in which each time a frame is received, the source address of the received frame is registered in the learning table so as to be associated with the port through which the received frame was received, and the received frame is relayed via the port corresponding to the source address coincident with the destination address of the received frame, the method comprising:
temporarily postponing the relay of the received frame in the case that the source address coincident with the destination address of the received frame has not been registered in the learning table, and for transmitting an inquiry frame inquiring whether the source address coincident with the destination address of the received frame has been registered in the learning table to the relay devices connected to the ports other than the port through which the received frame was received;
judging whether the source address coincident with the destination address to be inquired has been registered in the learning table in the case that the inquiry frame was received;
transmitting a response frame with the result of the inquiry to the effect that the source address coincident with the destination address to be inquired has been registered in the learning table to the relay device from which the inquiry frame was transmitted in the case that the registration judging step has judged that the source address coincident with the destination address to be inquired has been registered in the learning table; and
relaying the received frame whose relay has been temporarily postponed via the receiving port for the response frame in the case that the response frame was received.
